(19) United States
(12) Patent Application Publication
(10) Pub. No.: US 2010/0116902 A1
(43) Pub. Date: May 13, 2010

(54) REVERSIBLE AIR-ASSISTED AIRLESS SPRAY TIP

(76) Inventors: Steven D. Becker, Blaine, MN (US); Allonzo Baron Seran, III, Orono, MN (US); Jimmy Wing Sum Tam, Plymouth, MN (US)

Correspondence Address: GRACO MINNESOTA INC, PO BOX 1441, MINNEAPOLIS, MN, 55440, US

(21) Appl. No.: 12/594,840

(22) PCT Filed: Apr. 3, 2008
(86) PCT No.: PCT/US08/59288

§ 371 Date: Oct. 6, 2009

Related U.S. Application Data
(60) Provisional application No. 60/911,011, filed on Apr. 10, 2007.

(51) Int. Cl. B05B 15/02

(52) U.S. Cl. 239/119

(57) ABSTRACT

The device (10) utilizes a standard reversible airless tip (12). The air cap (18) is provided with four air passages (20) which aim radially inwardly at 45° from the centerline of the housing (30). The passages (20) have a 12° angle from being perpendicular to the longitudinal axis (24) of the assembly (10). The four jets (20) provided by these passages are guided by four channels (28) in the surface of the housing (30) (also having the 12° ramp angle) so as to guide the air flow to the center of the oval orifice (14a) in the carbide (14). Two pairs of opposing air jets (22) are also provided in the air cap (18) directed perpendicularly to the fan (26) of paint or other atomized material and these jets (22) are angled at about 20.5° relative to the plane that is perpendicular to the longitudinal axis (24) of the assembly (10). Each pair is directed at one another and is spaced laterally from the longitudinal axis (24) to help in removing tails from the pattern.

### TECHNICAL FIELD

This application claims the benefit of U.S. application Ser. No. 60/911,011, filed Apr. 10, 2007.

### BACKGROUND ART

Reversible airless spray tips are well known and have long been popular. Air-assisted airless spray guns have also been popular but have generally not included the ability to reverse the tip for cleaning clue to the difficulty in routing the required air passages to the front of the tip.

### DISCLOSURE OF THE INVENTION

The device of the instant invention utilizes a standard reversible tip such as Graco's FFT210. The air cap is provided with four air passages which aim radially inwardly and in the preferred embodiment are located 45° from the centerline of the housing. The passages have a 12° angle from being perpendicular to the longitudinal axis of the assembly. The four jets provided by these passages are guided by four channels in the surface of the housing (also having the 12° ramp angle) so as to guide the air flow to the center of the oval orifice in the carbide.

Two pairs of opposing air jets are also provided in the air cap directed perpendicularly to the fan of paint or other atomized material and these jets are angled at about 20.5° relative to the plane that is perpendicular to the longitudinal axis of the assembly. Each pair is directed at one another and is spaced laterally from the longitudinal axis to help in removing tails from the pattern.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a front perspective view of the rip assembly of the instant invention.

FIG. 2 is a front plan view of the air cap of the instant invention.

FIG. 3 is a sectional view taken along line 3-3 of FIG. 2.

FIG. 4 is a sectional view taken along line 4-4 of FIG. 2.

FIG. 5 is a front perspective view of the housing of the instant invention.

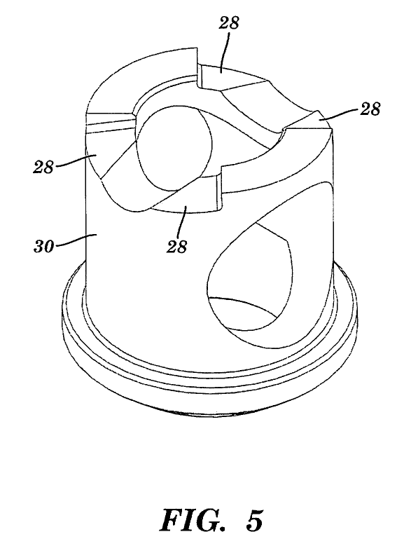

FIG. 6 is a front plan view of the housing of the instant invention.

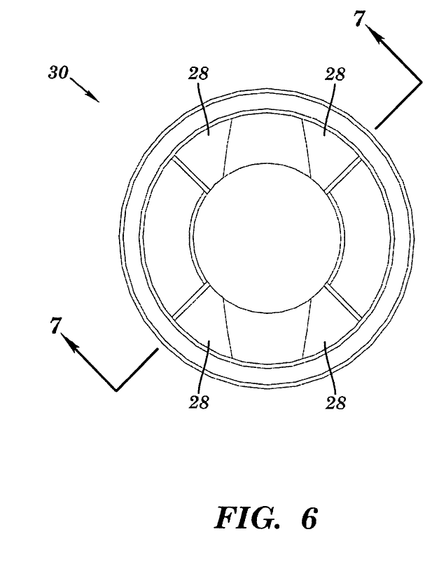

FIG. 7 is a sectional view taken along line 7-7 of FIG. 6.

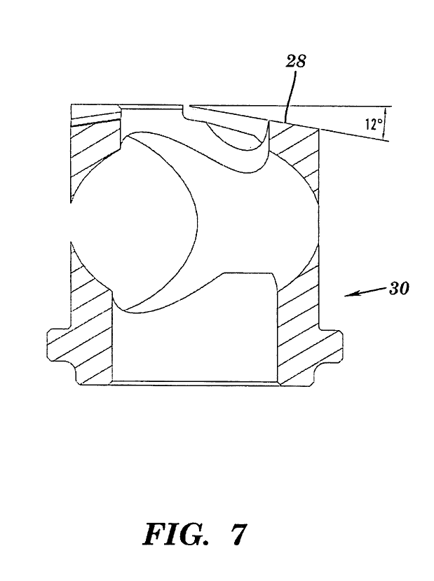

FIG. 8 is a front perspective view of an alternate embodiment of the tip assembly of the instant invention.

### BEST MODE FOR CARRYING OUT THE INVENTION

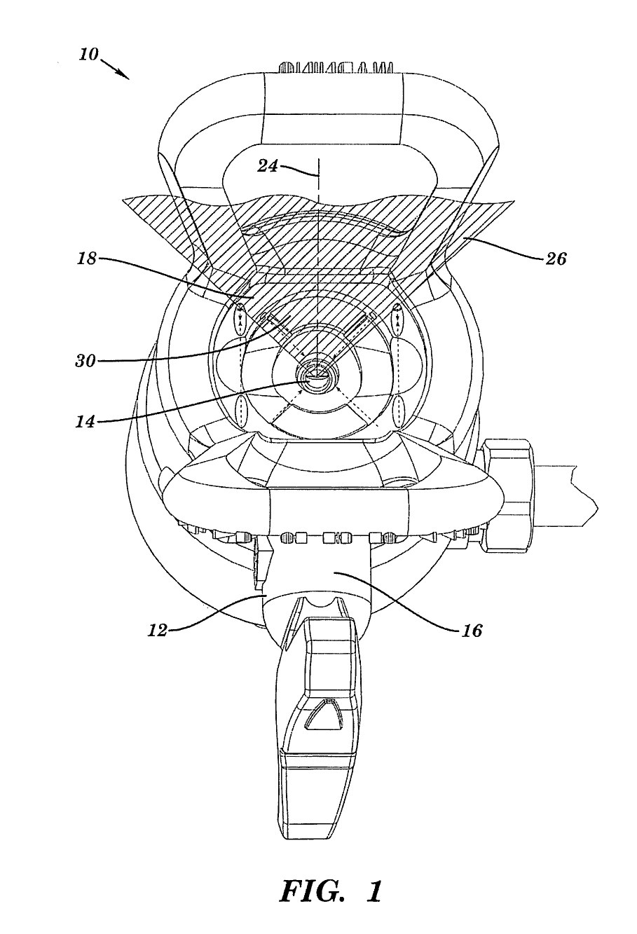

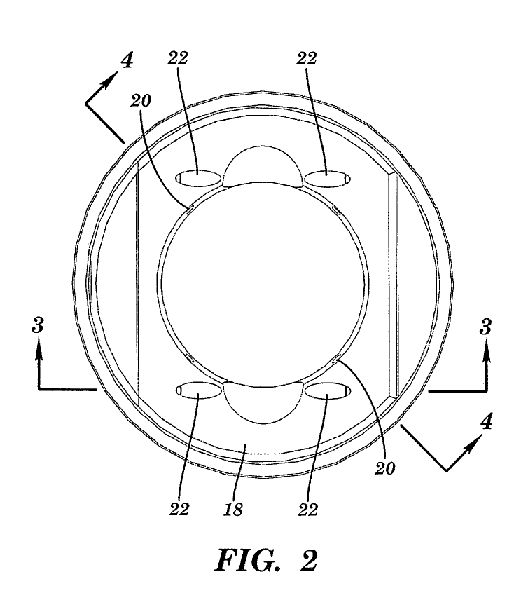

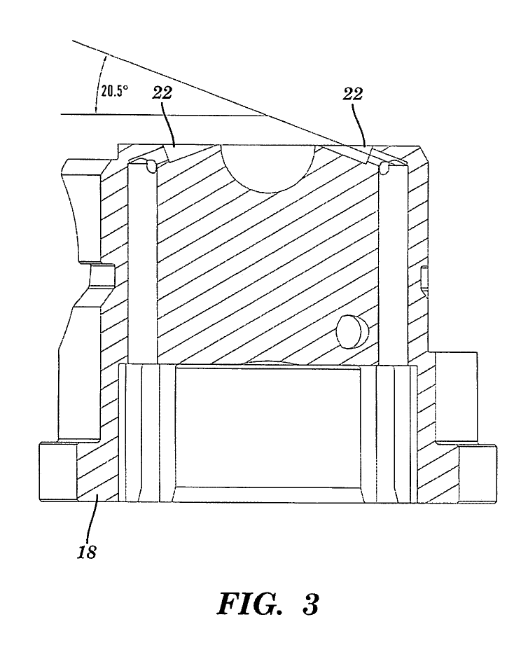

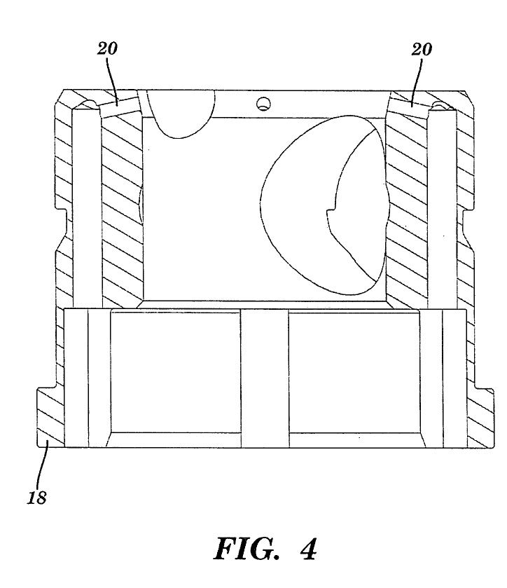

The air-assisted airless spray tip assembly is generally designated 10 in FIG. 1 and is comprised of a traditional reversible tip 12 having a carbide 14 wherein the cat-eye shaped orifice 14a is situated so that its major dimension is perpendicular to the barrel 16. Air cap 18 is shown in more detail in FIGS. 2-4 and is provided with first and second sets of jets 20 and 22 respectively. Ramp jets 20 are direct radially inwardly toward the longitudinal axis 24 of assembly 10 and slightly forwardly at an angle of about 12° relative to a plane that is perpendicular to the longitudinal axis 24 of assembly 10.

The second set of jets 22 are directed perpendicularly to the fan 26 and spaced laterally from the longitudinal axis 24. Jets 24 are angled at about 20.5° from the plane that is perpendicular to the longitudinal axis 24 of assembly 10.

Ramp jets 20 are located so as to direct the air flow along channel ramps 28 located on the front of housing 30 which also bear an angle of about 12° relative to a plane that is perpendicular to the longitudinal axis 24 of assembly 10 so as to guide the flow to the center of the oval or cat-eye shaped orifice 14a.

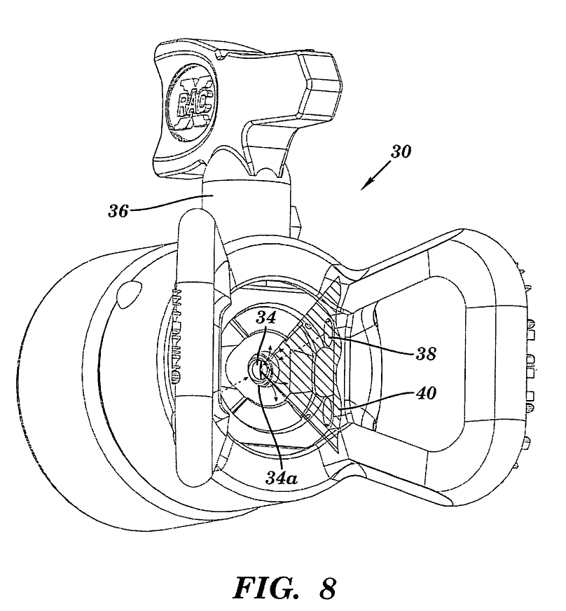

An alternative embodiment is shown in FIG. 8 wherein tip assembly 30 is comprised of a reversible tip 32 having a carbide 34 wherein the cat-eye shaped orifice 34a is situated so that its major dimension is parallel (not perpendicular as is typical in the prior art) to the barrel 36. A pair of jets 38 are directed at opposite sides of orifice 34a's major dimension and perpendicular to spray fan 40.

It is contemplated that various changes and modifications may he made to the tip assembly without departing from the spirit and scope of the invention as defined by the following claims.

1. A reversible spray tip assembly having a longitudinal axis, a housing and a rotatable barrel comprising a carbide having a cat-eye shaped orifice perpendicular to the axis of the barrel, the improvement comprising:
an air cap having first and second sets of air jets, said first set of air jets being directed radially inwardly towards said carbide; and
a housing located in said air cap containing channels for directing the air from said first set of air jets toward said carbide.

2. The reversible spray tip assembly of claim 1 wherein said first set of air jets are angled forwardly about 12° from a plane perpendicular to said longitudinal axis.

3. The reversible spray tip assembly of claim 1 wherein said first set of air jets are offset from said barrel axis by about 45°.

4. The reversible spray tip assembly of claim I wherein said second set of air jets are laterally offset from said longitudinal axis and directed perpendicularly to the fan produced by said carbide.

5. The reversible spray tip assembly of claim 4 wherein said second set of air jets are angled forwardly about 20.5° from a plane perpendicular to said longitudinal axis.

6. A reversible spray tip assembly having a longitudinal axis, a housing and it rotatable barrel comprising a carbide having a cat-eye shaped orifice, the improvement comprising;
said cat-eye shaped orifice being parallel to the axis of the barrel; and
an air cap having at least a pair of air jets aimed perpendicularly to said cat-eye shaped orifice.
